(19) United States
(12) Patent Application Publication
(10) Pub. No.: US 2023/0381944 A1
(43) Pub. Date: Nov. 30, 2023

(54) Mobile Tool Equipped Workstation Assembly

(71) Applicant: Mehrzad Mohajeri, Bellevue, WA (US)

(72) Inventor: Mehrzad Mohajeri, Bellevue, WA (US)

(21) Appl. No.: 17/827,866

(22) Filed: May 30, 2022

(51) Int. Cl. B25H 1/04; B25H 3/04; B25F 5/00; B23K 37/02

(52) U.S. Cl. CPC B25H 1/04; B25H 3/04; B25F 5/005; B23K 37/0294

(57) ABSTRACT

A mobile tool equipped workstation assembly for creating, repairing, and servicing jewelry includes a cart, which comprises an upper plate. An item that is to be manipulated can be positioned on an upper face of the upper plate. An air compressor is attached to the cart and a plurality of tools is removably attached to the cart. The tools are air powered. Each tool is operationally engaged to the air compressor by means of an associated air hose of a plurality of air hoses. Each tool has a respective function so that the plurality of tools comprises tools having a variety of functions. The tools are readily accessible to a user for mechanical manipulation, such as by drilling, sanding, polishing, and the like, of the item, such as an article of jewelry.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to workstation assemblies and more particularly pertains to a new workstation assembly for creating, repairing, and servicing jewelry. The present invention discloses a workstation assembly specifically designed to have air powered tools and fuel fired torches for use in crafting, repairing, and servicing jewelry that is mobile and thus positionable at a location desired by a jeweler.

### (2) Description of Related Art Including Information Disclosed Under 37 CFR 1.97 and 1.98

The prior art relates to workstation assemblies, which may comprise carts with compressors, sterilization units, tanks of compressed gas, outlets and power cords, tire mounting equipment, and the like. What is lacking in the prior art is a workstation assembly comprising . . .

### BRIEF SUMMARY OF THE INVENTION

An embodiment of the disclosure meets the needs presented above by generally comprising a cart, which comprises an upper plate, an upper face of which is configured for positioning of an item, such as an article of jewelry, to is to be manipulated. An air compressor is attached to the cart and a plurality of tools is removably attached to the cart. The tools are air powered. Each tool is operationally engaged to the air compressor by means of an associated air hose of a plurality of air hoses. Each tool has a respective function so that the plurality of tools comprises tools having a variety of functions. The tools are configured for mechanical manipulation of the item by drilling, sanding, polishing, and the like.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a mobile tool equipped workstation assembly according to an embodiment of the disclosure.

FIG. 2 is a front view of an embodiment of the disclosure.

FIG. 3 is a rear view of an embodiment of the disclosure.

FIG. 4 is an in-use view of an embodiment of the disclosure.

### DETAILED DESCRIPTION OF THE INVENTION

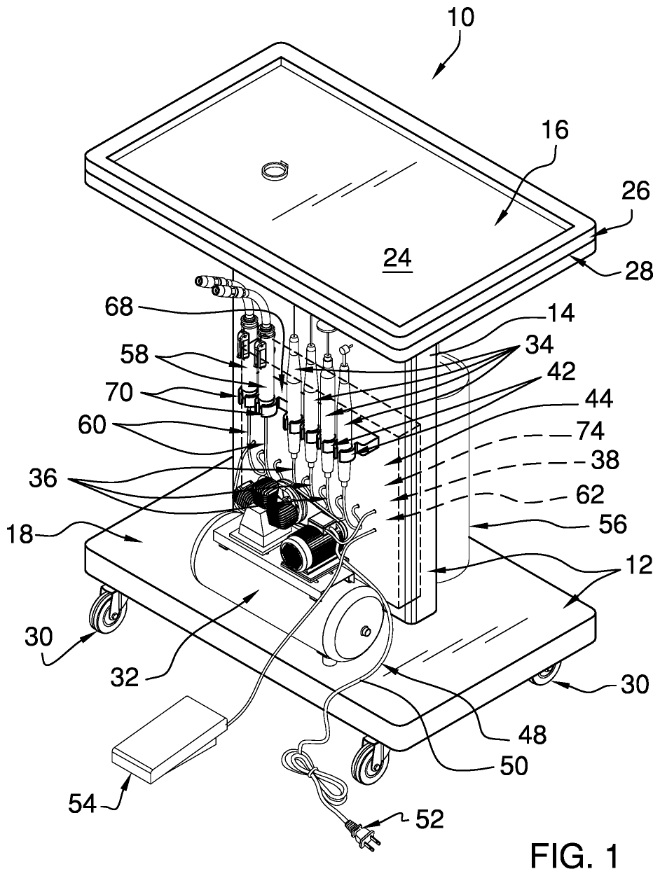

With reference now to the drawings, and in particular to FIGS. 1 through 4 thereof, a new workstation assembly embodying the principles and concepts of an embodiment of the disclosure and generally designated by the reference numeral 10 will be described.

As best illustrated in FIGS. 1 through 4, the mobile tool equipped workstation assembly 10 generally comprises a cart 12, which comprises a pedestal 14. An upper plate 16 and a lower plate 18 are attached to an upper end 20 and a lower end 22 of the pedestal 14, respectively. An upper face 24 of the upper plate 16 is configured for positioning of an item, such as an article of jewelry, which is to be manipulated. A lip 26 is attached to and extends circumferentially around a perimeter 28 of the upper plate 16. The lip 26 is configured to retain the item on the upper face 24 of the upper plate 16. A plurality of wheels 30 is attached to the lower plate 18 so that the cart 12 is rollable. The present invention anticipates respective wheels 30 being selectively lockable to prevent unintended movement of the cart 12.

An air compressor 32 is attached to the cart 12 and a plurality of tools 34 is removably attached to the cart 12. The tools 34 are air powered. Each tool 34 is operationally engaged to the air compressor 32 by means of an associated air hose 36 of a plurality of air hoses 36. Each tool 34 has a respective function so that the plurality of tools 34 comprises tools 34 having a variety of functions. The tools 34 are configured for mechanical manipulation of the item by drilling, sanding, polishing, and the like.

An air tool controller 38 is attached to the cart 12 and is operationally engaged to each of the tools 34 and the air compressor 32. The air tool controller 38 is enabled to engage a respective tool 34 selectively and operationally to the air compressor 32. The present invention anticipates the air tool controller 38 comprising actuated manifolds, multiport actuated valves, and the like, which are well known to those skilled in the art of gas delivery controllers.

An air tool holder 40, which comprises a plurality of air tool clips 42, is attached to a front wall 44 of the pedestal 14. Each air tool clip 42 is configured to removably engage a respective tool 34 to removably attach the respective tool 34 to the air tool holder 40. A plurality of air tool switches 46 is operationally engaged to the air tool controller 38. Each air tool switch 46 is attached to the air tool holder 40 within a respective air tool clip 42 so that the air tool switch 46 is activated upon removal of an associated tool 34 from the air tool clip 42 and deactivated upon insertion of the associated tool 34 into the air tool clip 42. The air tool switch 46 is enabled to selectively signal the air tool controller 38 to operationally engage the associated tool 34 to the air compressor 32 upon removal of the associated tool 34 from the respective air tool clip 42.

A power module 48 is engaged to the cart 12 and is operationally engaged to the air compressor 32. The power module 48 may comprise one or both of a power cord 50, as shown in FIG. 1, and a battery (not shown). A plug 52 of the power cord 50 is configured to engage an outlet to operationally engage the air compressor 32 to a source of electrical current. A pedal control 54 is operationally engaged to the air compressor 32 and the power module 48. The pedal control 54 is configured to be selectively engaged by a foot of a user to engage the air compressor 32 to the power module 48.

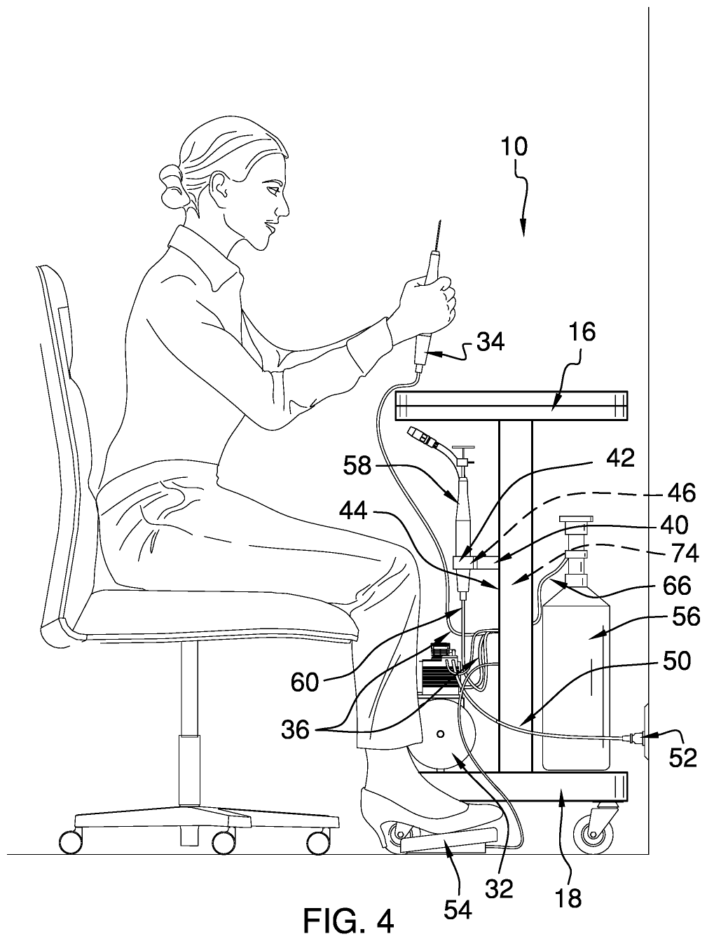

A fuel tank 56 is attached to the cart 12. As shown in FIG. 4, the fuel tank 56 and the air compressor 32 are positioned on the lower plate 18 and opposingly relative to the pedestal 14, which helps to balance the cart 12. A plurality of torches 58 is removably attached to the cart 12. Each torch 58 is operationally engaged to the fuel tank 56 by means of an associated fuel hose 60 of a plurality of fuel hoses 60. Each torch 58 has a respective function so that the plurality of torches 58 comprises torches 58 having a variety of functions. The torches 58 are configured for thermal manipulation of the item.

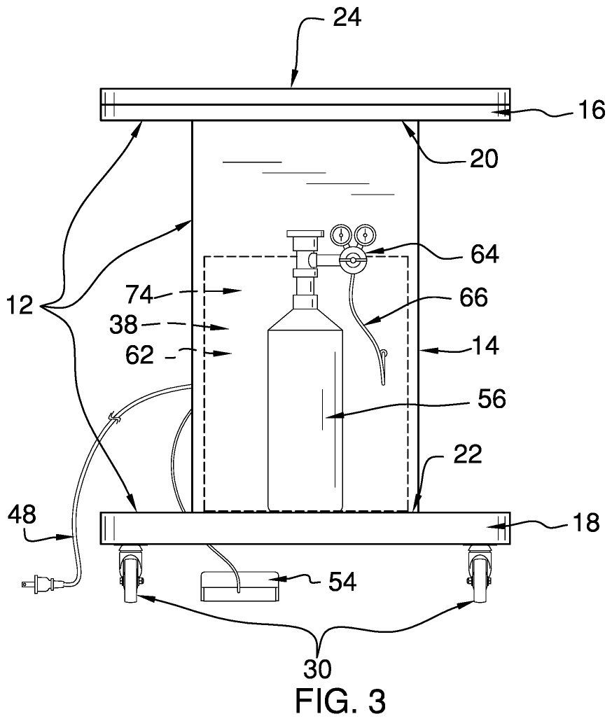

A thermal tool controller 62 is attached to the cart 12 and is operationally engaged to each of the torches 58 and the fuel tank 56. The thermal tool controller 62 is enabled to engage a respective torch 58 selectively and operationally to the fuel tank 56. The present invention anticipates the thermal tool controller 62 comprising actuated manifolds, multiport actuated valves, and the like, which are well known to those skilled in the art of gas delivery controllers. As shown in FIG. 3, a regulator 64 is attached to the fuel tank 56. A feeder hose 66 is attached to and extends between the regulator 64 and the thermal tool controller 62.

A thermal tool holder 68, which comprises a plurality of thermal tool clips 70, is attached to the front wall 44 of the pedestal 14. Each thermal tool clip 70 is configured to removably engage a respective torch 58 to removably attach the respective torch 58 to the thermal tool holder 68. A plurality of thermal tool switches 72 is operationally engaged to the thermal tool controller 62. Each thermal tool switch 72 is attached to the thermal tool holder 68 within a respective thermal tool clip 70 so that the thermal tool switch 72 is activated upon removal of an associated torch 58 from the thermal tool clip 70 and deactivated upon insertion of the associated torch 58 into the thermal tool clip 70. The thermal tool switch 72 is enabled to selectively signal the thermal tool controller 62 to operationally engage the associated torch 58 to the fuel tank 56 upon removal of the associated torch 58 from the respective thermal tool clip 70.

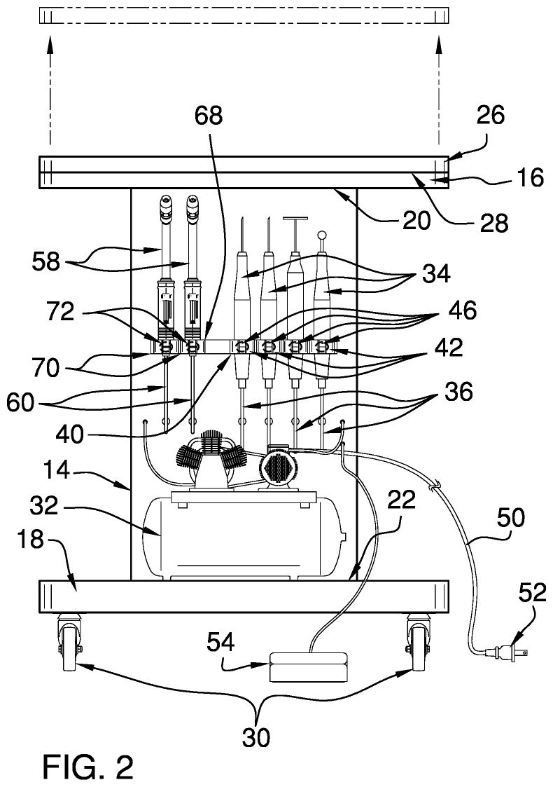

A cavity 74 is positioned in the pedestal 14. As shown in FIG. 2, the upper plate 16 is removably attached to the pedestal 14 so that the upper plate 16 is selectively detachable from the pedestal 14, thereby allowing access to the cavity 74. The air tool controller 38 and the thermal tool controller 62 are positioned in the cavity 74 and are accessible for servicing by removal of the upper plate 16. The air hoses 36 and the fuel hoses 60 extend through the front wall 44 of the pedestal 14 to the air tool controller 38 and the thermal tool controller 62, respectively.

In use, the cart 12 is rolled upon its wheels 30 to a desired location. The plug 52 of the power cord 50 is extended and engaged to an outlet to provide power to the air compressor 32. The fuel tank 56 is opened so that fuel flows to the thermal tool controller 62. Each tool 34 and torch 58 is available to a jeweler, as needed, to create or repair jewelry. Simply removing a tool 34 or a torch 58 from its associated air tool clip 42 or thermal tool clip 70 will actuate a corresponding one of the air tool controller 38 and thermal tool controller 62 so that the tool 34 or the torch 58 is ready to use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile tool equipped workstation assembly comprising:
a cart comprising an upper plate, wherein an upper face of the upper plate is configured for positioning of an item for manipulation;
an air compressor attached to the cart; and
a plurality of tools removably attached to the cart, the tools being air powered, each tool being operationally engaged to the air compressor by means of an associated air hose of a plurality of air hoses, each tool having a respective function, such that the plurality of tools comprises tools having a variety of functions, wherein the tools are configured for mechanical manipulation of the item.

2. The mobile tool equipped workstation assembly of claim 1, wherein the cart comprises:
a pedestal, the upper plate being attached to an upper end of the pedestal;
a lower plate attached to a lower end of the pedestal; and
a plurality of wheels attached to the lower plate, such that the cart is rollable.

3. The mobile tool equipped workstation assembly of claim 1, further including a lip attached to and extending circumferentially around a perimeter of the upper plate, wherein the lip is configured for retaining the item on the upper face of the upper plate.

4. The mobile tool equipped workstation assembly of claim 1, further including an air tool controller attached to the cart and operationally engaged to each of the tools and the air compressor, such that the air tool controller is enabled for selectively operationally engaging a respective tool to the air compressor.

5. The mobile tool equipped workstation assembly of claim 2, further including:
an air tool controller attached to the cart and operationally engaged to each of the tools and the air compressor, such that the air tool controller is enabled for selectively operationally engaging a respective tool to the air compressor;
an air tool holder comprising a plurality of air tool clips, the air tool holder being attached to a front wall of the pedestal, each air tool clip being configured for removably engaging a respective tool for removably attaching the respective tool to the air tool holder; and
a plurality of air tool switches operationally engaged to the air tool controller, each air tool switch being attached to the air tool holder within a respective air tool clip, such that the air tool switch is activated upon removal of an associated tool from the air tool clip and deactivated upon insertion of the associated tool into the air tool clip, such that the air tool switch is enabled for selectively signaling the air tool controller for operationally engaging the associated tool to the air compressor upon removal of the associated tool from the respective air tool clip.

6. The mobile tool equipped workstation assembly of claim 1, further including:
a power module engaged to the cart and operationally engaged to the air compressor; and
a pedal control operationally engaged to the air compressor and the power module, wherein the pedal control is configured for being selectively engaged by a foot of a user for engaging the air compressor to the power module.

7. The mobile tool equipped workstation assembly of claim 6, wherein the power module comprises a power cord, wherein a plug of the power cord is configured for engaging an outlet for operationally engaging the air compressor to a source of electrical current.

8. The mobile tool equipped workstation assembly of claim 5, further including:
a cavity positioned in the pedestal, the upper plate being removably attached to the pedestal, such that the upper plate is selectively detachable from the pedestal for accessing the cavity; and
the air tool controller being positioned in the cavity, the air hoses extending through the front wall of the pedestal to the air tool controller.

9. The mobile tool equipped workstation assembly of claim 2, further including:
a fuel tank attached to the cart; and
a plurality of torches removably attached to the cart, each torch being operationally engaged to the fuel tank by means of an associated fuel hose of a plurality of fuel hoses, each torch having a respective function, such that the plurality of torches comprises torches having a variety of functions, wherein the torches are configured for thermal manipulation of the item.

10. The mobile tool equipped workstation assembly of claim 9, further including a thermal tool controller attached to the cart and operationally engaged to each of the torches and the fuel tank, such that the thermal tool controller is enabled for selectively operationally engaging a respective torch to the fuel tank.

11. The mobile tool equipped workstation assembly of claim 9, further including:
a regulator attached to the fuel tank; and
a feeder hose attached to and extending between the regulator and the thermal tool controller.

12. The mobile tool equipped workstation assembly of claim 10, further including:
a thermal tool holder comprising a plurality of thermal tool clips attached to a front wall of the pedestal, each thermal tool clip being configured for removably engaging a respective torch for removably attaching the respective torch to the thermal tool holder; and
a plurality of thermal tool switches operationally engaged to the thermal tool controller, each thermal tool switch being attached to the thermal tool holder within a respective thermal tool clip, such that the thermal tool switch is activated upon removal of an associated torch from the thermal tool clip and deactivated upon insertion of the associated torch into the thermal tool clip, such that the thermal tool switch is enabled for selectively signaling the thermal tool controller for operationally engaging the associated torch to the fuel tank upon removal of the associated torch from the respective thermal tool clip.

13. The mobile tool equipped workstation assembly of claim 10, further including:
a cavity positioned in the pedestal, the upper plate being removably attached to the pedestal, such that the upper plate is selectively detachable from the pedestal for accessing the cavity; and
the thermal tool controller being positioned in the cavity, the fuel hoses extending through a front wall of the pedestal to the thermal tool controller.

14. A mobile tool equipped workstation assembly comprising:
a cart comprising an upper plate, wherein an upper face of the upper plate is configured for positioning of an item for manipulation, the cart comprising:
a pedestal, the upper plate being attached to an upper end of the pedestal,
a lip attached to and extending circumferentially around a perimeter of the upper plate, wherein the lip is configured for retaining the item on the upper face of the upper plate,
a lower plate attached to a lower end of the pedestal, and
a plurality of wheels attached to the lower plate, such that the cart is rollable;
an air compressor attached to the cart;
a plurality of tools removably attached to the cart, the tools being air powered, each tool being operationally engaged to the air compressor by means of an associated air hose of a plurality of air hoses, each tool having a respective function, such that the plurality of tools comprises tools having a variety of functions, wherein the tools are configured for mechanical manipulation of the item;
an air tool controller attached to the cart and operationally engaged to each of the tools and the air compressor, such that the air tool controller is enabled for selectively operationally engaging a respective tool to the air compressor;
an air tool holder comprising a plurality of air tool clips, the air tool holder being attached to a front wall of the pedestal, each air tool clip being configured for removably engaging a respective tool for removably attaching the respective tool to the air tool holder;
a plurality of air tool switches operationally engaged to the air tool controller, each air tool switch being attached to the air tool holder within a respective air tool clip, such that the air tool switch is activated upon removal of an associated tool from the air tool clip and deactivated upon insertion of the associated tool into the air tool clip, such that the air tool switch is enabled for selectively signaling the air tool controller for operationally engaging the associated tool to the air compressor upon removal of the associated tool from the respective air tool clip;
a power module engaged to the cart and operationally engaged to the air compressor, the power module comprising a power cord, wherein a plug of the power cord is configured for engaging an outlet for operationally engaging the air compressor to a source of electrical current; and
a pedal control operationally engaged to the air compressor and the power module, wherein the pedal control is configured for being selectively engaged by a foot of a user for engaging the air compressor to the power module;
a fuel tank attached to the cart;
a plurality of torches removably attached to the cart, each torch being operationally engaged to the fuel tank by means of an associated fuel hose of a plurality of fuel hoses, each torch having a respective function, such that the plurality of torches comprises torches having a variety of functions, wherein the torches are configured for thermal manipulation of the item;
a thermal tool controller attached to the cart and operationally engaged to each of the torches and the fuel tank, such that the thermal tool controller is enabled for selectively operationally engaging a respective torch to the fuel tank;
a regulator attached to the fuel tank;
a feeder hose attached to and extending between the regulator and the thermal tool controller;
a thermal tool holder comprising a plurality of thermal tool clips attached to a front wall of the pedestal, each thermal tool clip being configured for removably engaging a respective torch for removably attaching the respective torch to the thermal tool holder;
a plurality of thermal tool switches operationally engaged to the thermal tool controller, each thermal tool switch being attached to the thermal tool holder within a respective thermal tool clip, such that the thermal tool switch is activated upon removal of an associated torch from the thermal tool clip and deactivated upon insertion of the associated torch into the thermal tool clip, such that the thermal tool switch is enabled for selectively signaling the thermal tool controller for operationally engaging the associated torch to the fuel tank upon removal of the associated torch from the respective thermal tool clip; and
a cavity positioned in the pedestal, the upper plate being removably attached to the pedestal, such that the upper plate is selectively detachable from the pedestal for accessing the cavity, the air tool controller and the thermal tool controller being positioned in the cavity, the air hoses and the fuel hoses extending through the front wall of the pedestal to the air tool controller and the thermal tool controller, respectively.
